(19) United States
(12) Patent Application Publication
(10) Pub. No.: US 2023/0139558 A1
(43) Pub. Date: May 4, 2023

(54) DEVICES AND METHODS FOR FACILITATING DISCOVERY REFERENCE SIGNAL TRANSMISSIONS

(71) Applicant: QUALCOMM Incorporated, San Diego, CA (US)

(72) Inventors: Chih-Hao LIU, San Diego, CA (US); Yisheng XUE, San Diego, CA (US); Jing SUN, San Diego, CA (US); Xiaoxia ZHANG, San Diego, CA (US); Changlong XU, Beijing (CN)

(21) Appl. No.: 17/917,530

(22) PCT Filed: Apr. 16, 2020
(86) PCT No.: PCT/CN2020/085022

§ 371 Date: Oct. 6, 2022

(51) Int. Cl. H04L 5/00

(52) U.S. Cl. CPC H04L 5/0048; H04L 5/0053

(57) ABSTRACT

Wireless communication devices are adapted to facilitate discovery reference signal transmissions. According to one example, a wireless communication device can schedule a discovery reference signal (DRS) window including a plurality of synchronization signal blocks (SSBs) per QCL'd beam, a first coreset, and a second coreset. The wireless communication device may further transmit the generated DRS window. Additional wireless communication devices may receive a wireless transmission including a DRS window with a plurality of SSBs on each of a plurality of QCL'd beams, a first coreset, and a second coreset. At least one SSB and at least the first coreset may be detected, and a PDCCH may be decoded. Other aspects, embodiments, and features are also included.

### TECHNICAL FIELD

The technology discussed below relates generally to wireless communication systems, and more particularly, to devices and methods for facilitating discovery reference signal transmissions.

### INTRODUCTION

Wireless communications systems are widely deployed to provide various types of communication content such as voice, video, packet data, messaging, broadcast, and so on. These systems may be accessed by various types of devices adapted to facilitate wireless communications, where multiple devices share the available system resources (e.g., time, frequency, and power).

As the demand for mobile broadband access continues to increase, research and development continue to advance wireless communication technologies not only to meet the growing demand for mobile broadband access, but to advance and enhance the user experience with mobile communications. For example, the third generation partnership project (3GPP) is an organization that develops and maintains telecommunication standards for fourth generation (4G) long-term evolution (LTE) networks. Recently, the 3GPP has begun the development of a next-generation evolution of LTE called New Radio (NR), which may correspond to a fifth generation (5G) network. As it stands today, 5G NR networks may exhibit a higher degree of flexibility and scalability than LTE, and are envisioned to support very diverse sets of requirements. Techniques applicable in such networks for facilitating coverage enhancements for synchronization signal blocks (SSBs) and remaining minimum system information (RMSI) may be desirable.

### BRIEF SUMMARY OF SOME EXAMPLES

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

Various examples and implementations of the present disclosure facilitate wireless communications for wireless communications systems. In at least one aspect of the present disclosure, apparatus for wireless communications are provided. In at least one example, an apparatus for wireless communications may include a transceiver, a memory, and a processing circuit coupled to the transceiver and the memory. The processing circuit may be configured to schedule a discovery reference signal (DRS) window including a plurality of synchronization signal block (SSB) repetitions per beam, a first coreset, and a second coreset. The processing circuit may further be configured to transmit the scheduled DRS window.

Further aspects provide methods of wireless communication and/or wireless communication devices including means to perform such methods. One or more examples of such methods may include generating a discovery reference signal window including a plurality of synchronization signal blocks on each of a plurality of quasi co-located beams, a first coreset, and a second coreset. Further, the discovery reference signal window may be transmitted.

Still further aspects of the present disclosure include computer-readable storage mediums storing processor-executable programming In at least one example, the processor-executable programming may be adapted to cause a processing circuit to generate a discovery reference signal window including a plurality of synchronization signal blocks on each of a plurality of quasi co-located beams, a first coreset, and a second coreset; and to transmit the discovery reference signal window.

In at least one example, an apparatus for wireless communications may include a transceiver, a memory, and a processing circuit coupled to the transceiver and the memory. The processing circuit may be configured to receive, via the transceiver, a wireless transmission including a DRS window with a plurality of SSBs on each of a plurality of quasi co-located beams, a first coreset, and a second coreset. The processing circuit may further be configured to detect at least one SSB and at least the first coreset, as well as to decode a PDCCH.

Further aspects provide methods of wireless communication and/or wireless communication devices including means to perform such methods. One or more examples of such methods may include receiving a wireless transmission including a DRS window with a plurality of SSBs on each of a plurality of quasi co-located beams, a first coreset, and a second coreset; detecting at least one SSB and at least the first coreset; and decoding a PDCCH.

Still further aspects of the present disclosure include computer-readable storage mediums storing processor-executable programming In at least one example, the processor-executable programming may be adapted to cause a processing circuit to receive a wireless transmission including a DRS window with a plurality of SSBs on each of a plurality of quasi co-located beams, a first coreset, and a second coreset; to detect at least one SSB and at least the first coreset; and to decode a PDCCH.

These and other aspects of the invention will become more fully understood upon a review of the detailed description, which follows. Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 is a schematic diagram illustrating an example of a wireless communication system according to some embodiments.

FIG. 2 is a conceptual diagram illustrating an example of a radio access network according to some embodiments.

FIG. 3 is a block diagram illustrating an example of a wireless communication system supporting multiple-input multiple-output (MIMO) communication according to some embodiments.

FIG. 4 is a schematic diagram illustrating organization of wireless resources in an air interface utilizing orthogonal frequency divisional multiplexing (OFDM).

FIG. 5 is a block diagram illustrating a channel map relating to the usage of resource elements for SSB repetition in a transmission scheme according to at least one example.

FIG. 6 is a block diagram illustrating a channel map relating to the usage of resource elements for SSB repetition and an extended coreset in a transmission scheme according to at least one example.

FIG. 7 is a block diagram illustrating a channel map relating to the usage of resource elements for SSB repetition and an extended coreset in a transmission scheme according to at least one example.

FIG. 8 is a block diagram illustrating a channel map relating to the usage of resource elements for CCEs in an extended coreset according to at least one example.

FIG. 9 is a block diagram illustrating a channel map relating to the usage of resource elements for CCEs in an extended coreset according to at least one other example.

FIG. 10 is a block diagram conceptually illustrating an example of a hardware implementation for a scheduling entity according to some embodiments.

FIG. 11 is a flow diagram illustrating a wireless communication method according to some embodiments.

FIG. 12 is a block diagram conceptually illustrating an example of a hardware implementation for a scheduled entity according to some embodiments.

FIG. 13 is a flow diagram illustrating a wireless communication method according to some embodiments.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form to avoid obscuring such concepts.

While aspects and embodiments are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and other non-module-component based devices (e.g., end-user devices, vehicles, communication devices, computing devices, industrial equipment, retail/purchasing devices, medical devices, AI-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or OEM devices or systems incorporating one or more aspects of the described innovations. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

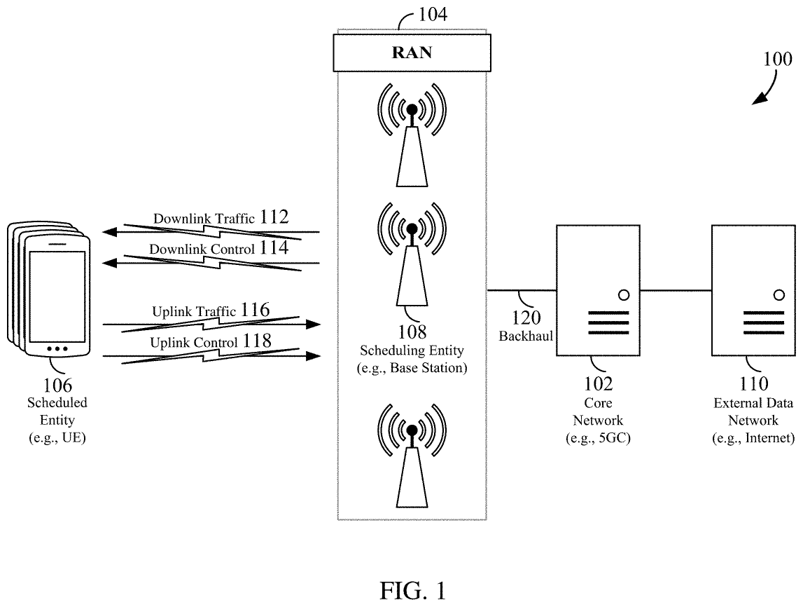

The various concepts presented throughout this disclosure may be implemented across a broad variety of telecommunication systems, network architectures, and communication standards. Referring now to FIG. 1, as an illustrative example without limitation, various aspects of the present disclosure are illustrated with reference to a wireless communication system 100. The wireless communication system 100 includes three interacting domains: a core network 102, a radio access network (RAN) 104, and a user equipment (UE) 106. By virtue of the wireless communication system 100, the UE 106 may be enabled to carry out data communication with an external data network 110, such as (but not limited to) the Internet.

The RAN 104 may implement any suitable wireless communication technology or technologies to provide radio access to the UE 106. As one example, the RAN 104 may operate according to 3^{rd} Generation Partnership Project (3GPP) New Radio (NR) specifications, often referred to as 5G. As another example, the RAN 104 may operate under a hybrid of 5G NR and Evolved Universal Terrestrial Radio Access Network (eUTRAN) standards, often referred to as LTE. The 3GPP refers to this hybrid RAN as a next-generation RAN, or NG-RAN. Of course, many other examples may be utilized within the scope of the present disclosure.

As illustrated, the RAN 104 includes a plurality of base stations 108. Broadly, a base station is a network element in a radio access network responsible for radio transmission and reception in one or more cells to or from a UE. In different technologies, standards, or contexts, a base station may variously be referred to by those skilled in the art as a base transceiver station (BTS), a radio base station, a radio transceiver, a transceiver function, a basic service set (BSS), an extended service set (ESS), an access point (AP), a Node B (NB), an eNode B (eNB), a gNode B (gNB), or some other suitable terminology.

The radio access network 104 is further illustrated supporting wireless communication for multiple mobile apparatuses. A mobile apparatus may be referred to as user equipment (UE) in 3GPP standards, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus (e.g., a mobile apparatus) that provides a user with access to network services.

Within the present document, a “mobile” apparatus need not necessarily have a capability to move, and may be stationary. The term mobile apparatus or mobile device broadly refers to a diverse array of devices and technologies. UEs may include a number of hardware structural components sized, shaped, and arranged to help in communication; such components can include antennas, antenna arrays, RF chains, amplifiers, one or more processors, etc. electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of things” (IoT). A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc., an industrial automation and enterprise device, a logistics controller, agricultural equipment, military defense equipment, vehicles, aircraft, ships, and weaponry, etc. Still further, a mobile apparatus may provide for connected medicine or telemedicine support, e.g., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

Wireless communication between a RAN 104 and a UE 106 may be described as utilizing an air interface. Transmissions over the air interface from a base station (e.g., base station 108) to one or more UEs (e.g., UE 106) may be referred to as downlink (DL) transmission. In accordance with certain aspects of the present disclosure, the term downlink may refer to a point-to-multipoint transmission originating at a scheduling entity (described further below; e.g., base station 108). Another way to describe this scheme may be to use the term broadcast channel multiplexing. Transmissions from a UE (e.g., UE 106) to a base station (e.g., base station 108) may be referred to as uplink (UL) transmissions. In accordance with further aspects of the present disclosure, the term uplink may refer to a point-to-point transmission originating at a scheduled entity (described further below; e.g., UE 106).

In some examples, access to the air interface may be scheduled, wherein a scheduling entity (e.g., a base station 108) allocates resources for communication among some or all devices and equipment within its service area or cell. Within the present disclosure, as discussed further below, the scheduling entity may be responsible for scheduling, assigning, reconfiguring, and releasing resources for one or more scheduled entities. That is, for scheduled communication, UEs 106, which may be scheduled entities, may utilize resources allocated by the scheduling entity 108.

Base stations 108 are not the only entities that may function as scheduling entities. That is, in some examples, a UE may function as a scheduling entity, scheduling resources for one or more scheduled entities (e.g., one or more other UEs).

As illustrated in FIG. 1, a scheduling entity 108 may broadcast downlink traffic 112 to one or more scheduled entities 106. Broadly, the scheduling entity 108 is a node or device responsible for scheduling traffic in a wireless communication network, including the downlink traffic 112 and, in some examples, uplink traffic 116 from one or more scheduled entities 106 to the scheduling entity 108. On the other hand, the scheduled entity 106 is a node or device that receives downlink control information 114, including but not limited to scheduling information (e.g., a grant), synchronization or timing information, or other control information from another entity in the wireless communication network such as the scheduling entity 108.

In general, base stations 108 may include a backhaul interface for communication with a backhaul portion 120 of the wireless communication system. The backhaul 120 may provide a link between a base station 108 and the core network 102. Further, in some examples, a backhaul network may provide interconnection between the respective base stations 108. Various types of backhaul interfaces may be employed, such as a direct physical connection, a virtual network, or the like using any suitable transport network.

The core network 102 may be a part of the wireless communication system 100, and may be independent of the radio access technology used in the RAN 104. In some examples, the core network 102 may be configured according to 5G standards (e.g., 5GC). In other examples, the core network 102 may be configured according to a 4G evolved packet core (EPC), or any other suitable standard or configuration.

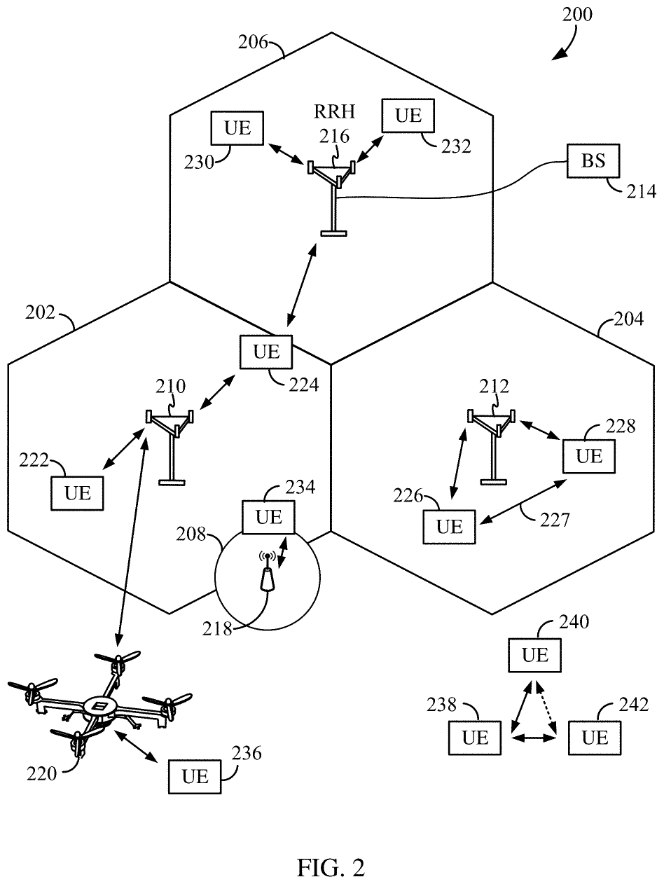

Referring now to FIG. 2, by way of example and without limitation, a schematic illustration of a RAN 200 is provided. In some examples, the RAN 200 may be the same as the RAN 104 described above and illustrated in FIG. 1. The geographic area covered by the RAN 200 may be divided into cellular regions (cells) that can be uniquely identified by a user equipment (UE) based on an identification broadcasted from one access point or base station. FIG. 2 illustrates macrocells 202, 204, and 206, and a small cell 208, each of which may include one or more sectors (not shown). A sector is a sub-area of a cell. All sectors within one cell are served by the same base station. A radio link within a sector can be identified by a single logical identification belonging to that sector. In a cell that is divided into sectors, the multiple sectors within a cell can be formed by groups of antennas with each antenna responsible for communication with UEs in a portion of the cell.

In FIG. 2, two base stations 210 and 212 are shown in cells 202 and 204, and a third base station 214 is shown controlling a remote radio head (RRH) 216 in cell 206. That is, a base station can have an integrated antenna or can be connected to an antenna or RRH by feeder cables. In the illustrated example, the cells 202, 204, and 206 may be referred to as macrocells, as the base stations 210, 212, and 214 support cells having a large size. Further, a base station 218 is shown in the small cell 208 (e.g., a microcell, picocell, femtocell, home base station, home Node B, home eNode B, etc.) which may overlap with one or more macrocells. In this example, the cell 208 may be referred to as a small cell, as the base station 218 supports a cell having a relatively small size. Cell sizing can be done according to system design as well as component constraints.

It is to be understood that the radio access network 200 may include any number of wireless base stations and cells. Further, a relay node may be deployed to extend the size or coverage area of a given cell. The base stations 210, 212, 214, 218 provide wireless access points to a core network for any number of mobile apparatuses. In some examples, the base stations 210, 212, 214, and/or 218 may be the same as the base station/scheduling entity 108 described above and illustrated in FIG. 1.

FIG. 2 further includes a quadcopter or drone 220, which may be configured to function as a base station. That is, in some examples, a cell may not necessarily be stationary, and the geographic area of the cell may move according to the location of a mobile base station such as the quadcopter 220.

Within the RAN 200, the cells may include UEs that may be in communication with one or more sectors of each cell. Further, each base station 210, 212, 214, 218, and 220 may be configured to provide an access point to a core network 102 (see FIG. 1) for all the UEs in the respective cells. For example, UEs 222 and 224 may be in communication with base station 210, UEs 226 and 228 may be in communication with base station 212, UEs 230 and 232 may be in communication with base station 214 by way of RRH 216, UE 234 may be in communication with base station 218, and UE 236 may be in communication with mobile base station 220. In some examples, the UEs 222, 224, 226, 228, 230, 232, 234, 236, 238, 240, and/or 242 may be the same as the UE/scheduled entity 106 described above and illustrated in FIG. 1.

In some examples, a mobile network node (e.g., quadcopter 220) may be configured to function as a UE. For example, the quadcopter 220 may operate within cell 202 by communicating with base station 210.

In a further aspect of the RAN 200, sidelink signals may be used between UEs without necessarily relying on scheduling or control information from a base station. For example, two or more UEs (e.g., UEs 226 and 228) may communicate with each other using peer to peer (P2P) or sidelink signals 227 without relaying that communication through a base station (e.g., base station 212). In a further example, UE 238 is illustrated communicating with UEs 240 and 242. Here, the UE 238 may function as a scheduling entity or a primary sidelink device, and UEs 240 and 242 may function as a scheduled entity or a non-primary (e.g., secondary) sidelink device. In still another example, a UE may function as a scheduling entity in a device-to-device (D2D), peer-to-peer (P2P), or vehicle-to-vehicle (V2V) network, and/or in a mesh network. In a mesh network example, UEs 240 and 242 may optionally communicate directly with one another in addition to communicating with the scheduling entity 238. Thus, in a wireless communication system with scheduled access to time-frequency resources and having a cellular configuration, a P2P configuration, or a mesh configuration, a scheduling entity and one or more scheduled entities may communicate utilizing the scheduled resources.

In the radio access network 200, the ability for a UE to communicate while moving, independent of its location, is referred to as mobility. The various physical channels between the UE and the radio access network are generally set up, maintained, and released under the control of an access and mobility management function (AMF, not illustrated, part of the core network 102 in FIG. 1), which may include a security context management function (SCMF) that manages the security context for both the control plane and the user plane functionality, and a security anchor function (SEAF) that performs authentication.

In some examples, the base stations 210, 212, and 214/216 may broadcast unified synchronization signals (e.g., unified Primary Synchronization Signals (PSSs), unified Secondary Synchronization Signals (SSSs) and unified Physical Broadcast Channels (PBCH)). The UEs 222, 224, 226, 228, 230, and 232 may receive the unified synchronization signals, derive the carrier frequency and slot timing from the synchronization signals, and in response to deriving timing, transmit an uplink pilot or reference signal. The uplink pilot signal transmitted by a UE (e.g., UE 224) may be concurrently received by two or more cells (e.g., base stations 210 and 214/216) within the radio access network 200. Each of the cells may measure a strength of the pilot signal, and the radio access network (e.g., one or more of the base stations 210 and 214/216 and/or a central node within the core network) may determine a serving cell for the UE 224. As the UE 224 moves through the radio access network 200, the network may continue to monitor the uplink pilot signal transmitted by the UE 224. When the signal strength or quality of the pilot signal measured by a neighboring cell exceeds that of the signal strength or quality measured by the serving cell, the network 200 may handover the UE 224 from the serving cell to the neighboring cell, with or without informing the UE 224.

Although the synchronization signal transmitted by the base stations 210, 212, and 214/216 may be unified, the synchronization signal may not identify a particular cell, but rather may identify a zone of multiple cells operating on the same frequency and/or with the same timing.

In various implementations, the air interface in the radio access network 200 may utilize licensed spectrum, unlicensed spectrum, or shared spectrum. Licensed spectrum provides for exclusive use of a portion of the spectrum, generally by virtue of a mobile network operator purchasing a license from a government regulatory body. Unlicensed spectrum provides for shared use of a portion of the spectrum without need for a government-granted license. While compliance with some technical rules is generally still required to access unlicensed spectrum, generally, any operator or device may gain access. Shared spectrum may fall between licensed and unlicensed spectrum, wherein technical rules or limitations may be required to access the spectrum, but the spectrum may still be shared by multiple operators and/or multiple RATs. For example, the holder of a license for a portion of licensed spectrum may provide licensed shared access (LSA) to share that spectrum with other parties, e.g., with suitable licensee-determined conditions to gain access.

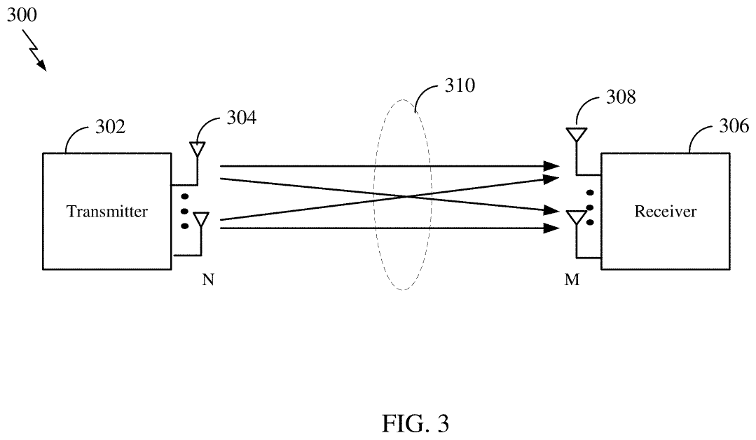

In some aspects of the disclosure, the scheduling entity and/or scheduled entity may be configured for beamforming and/or multiple-input multiple-output (MIMO) technology. FIG. 3 illustrates an example of a wireless communication system 300 supporting MIMO. In a MIMO system, a transmitter 302 includes multiple transmit antennas 304 (e.g., N transmit antennas) and a receiver 306 includes multiple receive antennas 308 (e.g., M receive antennas). Thus, there are N×M signal paths 310 from the transmit antennas 304 to the receive antennas 308. Each of the transmitter 302 and the receiver 306 may be implemented, for example, within a scheduling entity 108, a scheduled entity 106, or any other suitable wireless communication device.

The use of such multiple antenna technology enables the wireless communication system to exploit the spatial domain to support spatial multiplexing, beamforming, and transmit diversity. Spatial multiplexing may be used to transmit different streams of data, also referred to as layers, simultaneously on the same time-frequency resource. The data streams may be transmitted to a single UE to increase the data rate or to multiple UEs to increase the overall system capacity, the latter being referred to as multi-user MIMO (MU-MIMO). This is achieved by spatially precoding each data stream (i.e., multiplying the data streams with different weighting and phase shifting) and then transmitting each spatially precoded stream through multiple transmit antennas on the downlink. The spatially precoded data streams arrive at the UE(s) with different spatial signatures, which enables each of the UE(s) to recover the one or more data streams destined for that UE. On the uplink, each UE transmits a spatially precoded data stream, which enables the base station to identify the source of each spatially precoded data stream.

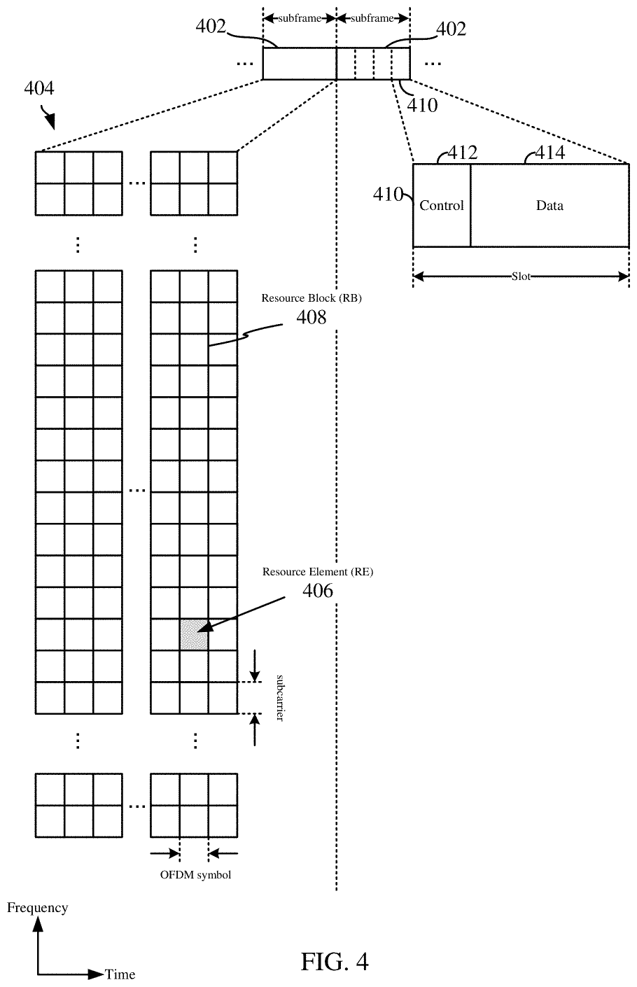

Various aspects of the present disclosure will be described with reference to an OFDM waveform, schematically illustrated in FIG. 4. It should be understood by those of ordinary skill in the art that the various aspects of the present disclosure may be applied to a DFT-s-OFDMA waveform in substantially the same way as described herein below. That is, while some examples of the present disclosure may focus on an OFDM link for clarity, it should be understood that the same principles may be applied as well to DFT-s-OFDMA waveforms.

Within the present disclosure, a frame refers to a duration of 10 ms for wireless transmissions, with each frame consisting of 10 subframes of 1 ms each. On a given carrier, there may be one set of frames in the UL, and another set of frames in the DL. Referring now to FIG. 4, an expanded view of an exemplary DL subframe 402 is illustrated, showing an OFDM resource grid 404. However, as those skilled in the art will readily appreciate, the PHY transmission structure for any particular application may vary from the example described here, depending on any number of factors. Here, time is in the horizontal direction with units of OFDM symbols; and frequency is in the vertical direction with units of subcarriers or tones.

The resource grid 404 may be used to schematically represent time-frequency resources for a given antenna port. That is, in a MIMO implementation with multiple antenna ports available, a corresponding multiple number of resource grids 404 may be available for communication. The resource grid 404 is divided into multiple resource elements (REs) 406. An RE, which is 1 subcarrier×1 symbol, is the smallest discrete part of the time-frequency grid, and contains a single complex value representing data from a physical channel or signal. Depending on the modulation utilized in a particular implementation, each RE may represent one or more bits of information. In some examples, a block of REs may be referred to as a physical resource block (PRB) or more simply a resource block (RB) 408, which contains any suitable number of consecutive subcarriers in the frequency domain In one example, an RB may include 12 subcarriers, a number independent of the numerology used. In some examples, depending on the numerology, an RB may include any suitable number of consecutive OFDM symbols in the time domain Within the present disclosure, it is assumed that a single RB such as the RB 408 entirely corresponds to a single direction of communication (either transmission or reception for a given device).

A UE generally utilizes only a subset of the resource grid 404. An RB may be the smallest unit of resources that can be allocated to a UE. Thus, the more RBs scheduled for a UE, and the higher the modulation scheme chosen for the air interface, the higher the data rate for the UE.

In this illustration, the RB 408 is shown as occupying less than the entire bandwidth of the subframe 402, with some subcarriers illustrated above and below the RB 408. In a given implementation, the subframe 402 may have a bandwidth corresponding to any number of one or more RBs 408. Further, in this illustration, the RB 408 is shown as occupying less than the entire duration of the subframe 402, although this is merely one possible example.

Each subframe 402 (e.g., a 1 ms subframe) may consist of one or multiple adjacent slots. In the example shown in FIG. 4, one subframe 402 includes four slots 410, as an illustrative example. In some examples, a slot may be defined according to a specified number of OFDM symbols with a given cyclic prefix (CP) length. For example, a slot may include 7 or 14 OFDM symbols with a nominal CP. Additional examples may include mini-slots having a shorter duration (e.g., 1, 2, 4, or 7 OFDM symbols). These mini-slots may in some cases be transmitted occupying resources scheduled for ongoing slot transmissions for the same or for different UEs.

An expanded view of one of the slots 410 illustrates the slot 410 including a control region 412 and a data region 414. In general, the control region 412 may carry control channels (e.g., PDCCH), and the data region 414 may carry data channels (e.g., PDSCH or PUSCH). Of course, a slot may contain all DL, all UL, or at least one DL portion and at least one UL portion. The simple structure illustrated in FIG. 4 is merely exemplary in nature, and different slot structures may be utilized, and may include one or more of each of the control region(s) and data region(s).

Although not illustrated in FIG. 4, the various REs 406 within a RB 408 may be scheduled to carry one or more physical channels, including control channels, shared channels, data channels, etc. Other REs 406 within the RB 408 may also carry pilots or reference signals. These pilots or reference signals may provide for a receiving device to perform channel estimation of the corresponding channel, which may enable coherent demodulation/detection of the control and/or data channels within the RB 408.

In a DL transmission, the transmitting device (e.g., the scheduling entity 108) may allocate one or more REs 406 (e.g., within a control region 412) to carry DL control information 114 including one or more DL control channels that generally carry information originating from higher layers, such as a physical broadcast channel (PBCH), a physical downlink control channel (PDCCH), etc., to one or more scheduled entities 106. In addition, DL REs may be allocated to carry DL physical signals that generally do not carry information originating from higher layers. These DL physical signals may include a primary synchronization signal (PSS); a secondary synchronization signal (SSS); demodulation reference signals (DM-RS); phase-tracking reference signals (PT-RS); channel-state information reference signals (CSI-RS); etc.

The synchronization signals PSS and SSS (collectively referred to as SS), and in some examples, the PBCH, may be transmitted in an SS block (SSB) that includes 4 consecutive OFDM symbols, numbered via a time index in increasing order from 0 to 3. In the frequency domain, the SS block may extend over 240 contiguous subcarriers, with the subcarriers being numbered via a frequency index in increasing order from 0 to 239. Of course, the present disclosure is not limited to this specific SS block configuration. Other nonlimiting examples may utilize greater or fewer than two synchronization signals; may include one or more supplemental channels in addition to the PBCH; may omit a PBCH; and/or may utilize nonconsecutive symbols for an SS block, within the scope of the present disclosure.

The PDCCH may carry downlink control information (DCI) for one or more UEs in a cell. This can include, but is not limited to, power control commands, scheduling information, a grant, and/or an assignment of REs for DL and UL transmissions.

In order for a UE to gain initial access to a cell, the RAN may provide system information (SI) characterizing the cell. This system information may be provided utilizing minimum system information (MSI), and other system information (OSI). The MSI may be periodically broadcast over the cell to provide the most basic information required for initial cell access, and for acquiring any OSI that may be broadcast periodically or sent on-demand. In some examples, the MSI may be provided over two different downlink channels. For example, the PBCH may carry a master information block (MIB), and the PDSCH may carry a system information block type 1 (SIB1). In the art, SIB1 may be referred to as the remaining minimum system information (RMSI).

OSI may include any SI that is not broadcast in the MSI. In some examples, the PDSCH may carry a plurality of SIBs, not limited to SIB1, discussed above. Here, the OSI may be provided in these SIBs, e.g., SIB2 and above.

The channels or carriers described above and illustrated in FIGS. 1 and 4 are not necessarily all the channels or carriers that may be utilized between a scheduling entity 108 and scheduled entities 106, and those of ordinary skill in the art will recognize that other channels or carriers may be utilized in addition to those illustrated, such as other traffic, control, and feedback channels.

These physical channels described above are generally multiplexed and mapped to transport channels for handling at the medium access control (MAC) layer. Transport channels carry blocks of information called transport blocks (TB). The transport block size (TBS), which may correspond to a number of bits of information, may be a controlled parameter, based on the modulation and coding scheme (MCS) and the number of RBs in a given transmission.

In instances where communications occur in an unlicensed spectrum, there is a possibility that the spectrum may be shared with other radio access technologies (RATs), such as WiFi and/or other networks deployed by other operators using other unlicensed radio nodes. To enable the co-existence of the various radio nodes, listen-before-talk (LBT) is typically utilized. LBT is a contention protocol in which the radio node determines whether a particular frequency channel is already occupied (e.g., by a node using another RAT) before using the particular frequency channel. That is, with LBT, data is only transmitted when a channel is sensed to be idle.

In 5G NR networks, reference signals, such as Discovery Reference Signals (DRS), may be transmitted to enable a UE to “discover” an active channel. For example, a UE may sense the DRS to determine appropriate time and frequency compensation parameters for the channel. For licensed spectrum, the DRS may be periodically transmitted. Due to the unpredictability of LBT, however, for unlicensed spectrum, periodic DRS transmissions may not be feasible.

Additionally, some UEs may be configured for NR-Light. NR-Light (also currently referred to as NR-Lite) may, for example, become a feature supported in a future standard (e.g., 3GPP Release 17 for 5G NR networks), where UEs may, among other features, operate with 1 or 2 antennas. As a result, a first try detection of SSB and RMSI may be challenging for such a UE.

Because unlicensed spectrum may not be feasible for periodic DRS, it would be desirable to improve the likelihood that a UE is able to detect the DRS during one DRS window, instead of having to receive multiple DRS windows. Various aspects of the present disclosure include techniques to improve the transmission of SSB and RMSI during a DRS window, resulting in improved detection by a UE.

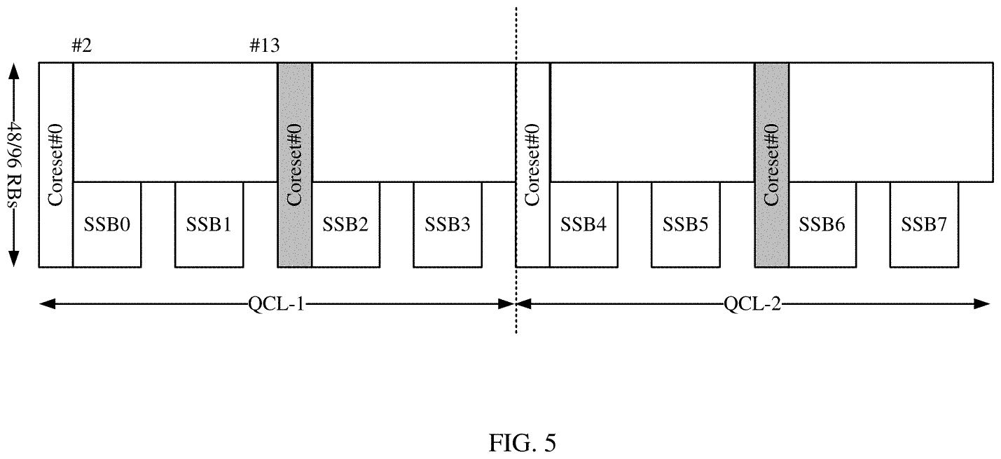

FIG. 5 is a block diagram illustrating a channel map relating to the usage of resource elements in a transmission scheme according to at least one example. According to at least one aspect of the present disclosure, a DRS window may be increased to facilitate up to four SSB repetitions per beam. In certain implementations, the DRS window is 5 ms and may have contiguous SSB transmission for up to X SSBs, where X is 1, 2, 4, or 8. To facilitate an increase in likelihood of receiving the SSB in one DRS window, a DRS window may be increased, such as up to 10 ms or some other multiple of 5 ms, with X increased up to 32 to facilitate up to 4 SSB repetitions per beam. For example, X may be 1, 2, 4, 8, 16, or 32. With X equal to 32, the SSB can be repeated 4 times for up to eight beams with different quasi co-location (QCL).

In the example shown in FIG. 5, two beams are depicted as QCL-1 and QCL-2. As depicted, each beam may include up to 4 SSB repetitions. For example, the first beam, QCL-1, includes SSB repetitions depicted as SSB0, SSB1, SSB2, and SSB3. Similarly, the second beam, QCL-2, includes SSB repetitions depicted as SSB4, SSBS, SSB6, and SSB7. In different embodiments, the number of SSB repetitions may vary, for example, between 2 repetitions and 4 repetitions for each beam. Increasing the number of SSB repetitions per beam may improve the ability of a UE to receive the SSB in a single DRS window.

The DRS window may further include a coreset (Control Resource Set). In a 5G NR system, for example, a coreset for PDCCH includes various fields used in a coreset information element. In LTE, control channels may be allocated across the entire system bandwidth. This tends to make it difficult to control inter-cell interference. To address this, a 5G NR system may employ PDCCHs transmitted in specifically designated coresets. The coreset may be generalized with a set of RBs and OFDM symbols. REs in a coreset may, for example, organized in RE Groups (REGs), where each REG includes 12 REs of one OFDM symbol in one RB. A PDCCH channel may be confined to one coreset and transmitted with its own DMRS. The PDCCH channel may, for example, be carried by 1, 2, 4, 8, or 16 control channel elements (CCEs) to carry various DCI payload sizes or coding rates. Each CCE may include 6 RE Groups (REGs). Further, a CCE to REG mapping for a coreset can be interleaved or non-interleaved according to different implementations.

In implementations utilizing a 30 KHz subcarrier spacing, the coreset may, for example, utilize 48 RBs and 2 symbols with 16 CCEs. In such an example, the PDCCH supports an aggregation level of 16, related to the 16 CCEs. In instances where a UE is utilizing only one or two antennas, the PDCCH may benefit from higher aggregation levels, such as aggregation levels of 32 or 64, which is provided by providing additional CCEs.

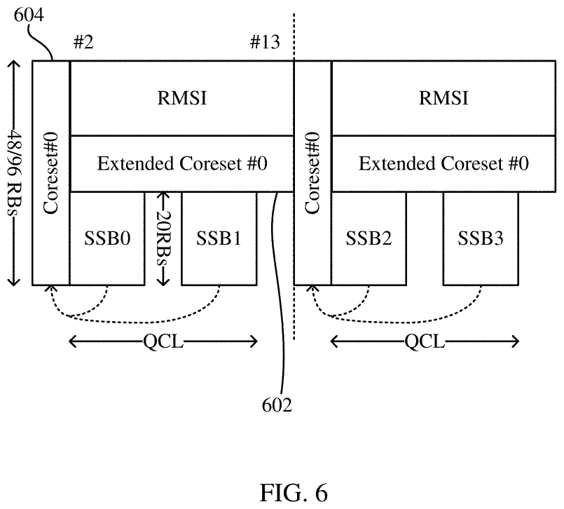

According to one or more aspects of the disclosure, an extended coreset may be utilized. FIG. 6 is a block diagram illustrating a channel map relating to the usage of resource elements in a transmission scheme according to at least one example. As shown, an extended coreset 602 is provided. In the depicted example, the extended coreset 602 is positioned immediately following a legacy coreset 604. More specifically, the depicted example illustrates a legacy coreset 604 utilizing the first 2 symbols (i.e., symbols 0 and 1), with an extended coreset 602 starting at the next symbol, e.g., symbol 2. The number of symbols occupied by an extended coreset 602 may vary. In one example, an extended coreset 602 may occupy 5 or 6 symbols. Such an example may be utilized for subcarrier spacing of 15 KHz, as 7 symbols is 0.5 ms. In another example, an extended coreset 602 may occupy 12 or 13 symbols. Such an example may be utilized for subcarrier spacing of 30 KHz.

The number of RBs utilized for an extended coreset 602 may vary. In one example, a number and location of RBs may be specified or predefined for different subcarrier spacing. In one example, a number of RBs occupied by the extended coreset may be 48 RBs. For instance, in the depicted implementation, if a number of RBs is 96, then an extended coreset 602 may occupy 48 of the 96 RBs. In another example, if the available RBs is 48, an extended coreset 602 may occupy the remaining 48 RBs, e.g., not occupied by the SSBs.

In the examples given above, an extended coreset 602 occupying 6 symbols and 48 RBs (e.g., half of the 96 RBs in a 15 KHz SCS) may result in an additional 40 CCEs available. In another example, an extended coreset 602 occupying 12 symbols for 24 RBs (e.g., half of the 48 RBs in a 30 KHz SCS) may result in an additional 48 CCEs available.

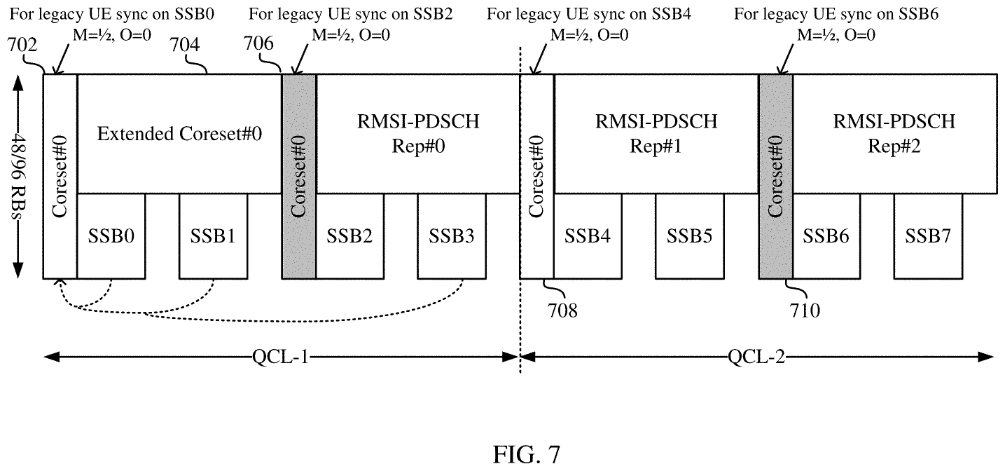

In some aspects of the disclosure, an extended coreset 602 may be configured for recognition by NR-Light UEs or the like, while other UEs, such as legacy UEs, may identify the initial coreset. For example, referring to FIG. 7, the contiguous SSB repetitions which are QCL'd may all map to the same PDCCH. For NR-Light UEs, the NR-Light UE may monitor the first PDCCH in a first coreset 702 plus an extended coreset 704. As depicted, each of the SSBs in a first beam indicated as QCL-1 can map to the first coreset 702 of the QCL'd SSB repetitions, which includes SSB0, SSB1, SSB2, and SSB3. For example, a NR-Light UE may be mapped to a first coreset 702 and the extended coreset 704 from SSB0 and/or SSB1. Similarly, a NR-Light UE may be mapped to the same first coreset 702 and an extended coreset 704 from SSB2 and/or SSB3. On the other hand, a legacy UE or the like may be mapped to a first coreset 702 from SSB0 and/or SSB1, but not an extended coreset, and may be mapped to a second coreset 706 from SSB2 and/or SSB3 for a first beam QCL-1. Similarly, for a second beam QCL-2, a NR-Light UE or the like may be mapped to the coreset 708 from SSB4, SSB5, SSB6, and/or SSB7, while a legacy UE or the like may be mapped to the coreset 708 from SSB4 and/or SSB5 and to coreset 710 from SSB6 and/or SSB7.

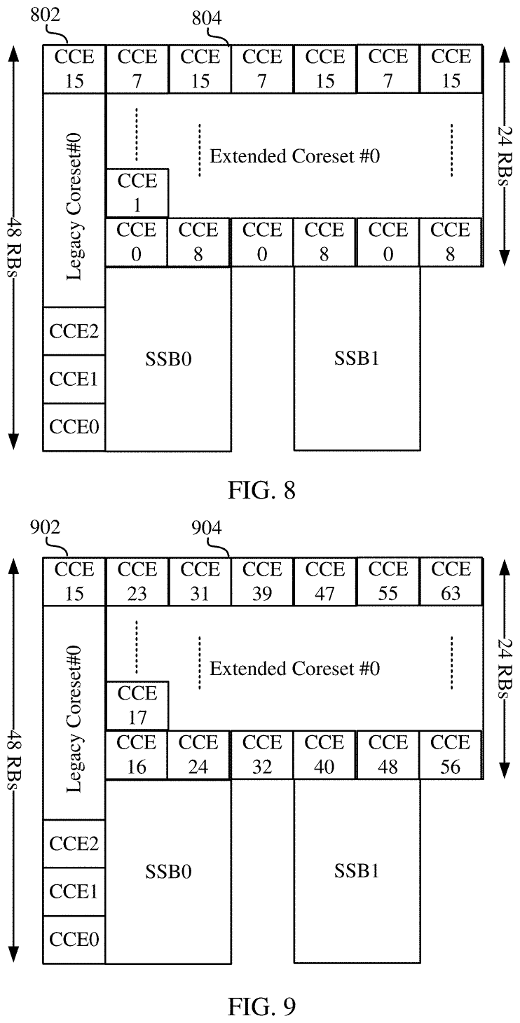

In some embodiments, an extended coreset may include a repetition of the CCEs included in an original coreset. For example, FIG. 8 is a block diagram illustrating a channel map relating to the usage of resource elements for CCEs in an extended coreset according to at least one example. In the example of FIG. 8, a legacy coreset 802 includes CCE0 through CCE15. In an extended coreset 804, the CCEs of the legacy coreset 802 are repeated. In the depicted example, the CCE repetition includes mapping the CCEs in frequency and then time, as depicted. Further in the depicted example, a legacy coreset 802 may be repeated 3 full times in an extended coreset 804. A NR-Light UE or the like can therefore combine the repeated CCEs in the extended coreset 804 to possibly improve coverage. In this example, the NR-Light UE receives four times more CCEs for LLRs during decoding. That is, the NR-Light UE can combine the LLRs for the repeated CCEs to possibly improve coverage.

Turning now to FIG. 9, a block diagram is shown illustrating a channel map relating to the usage of resource elements for CCEs in an extended coreset according to at least one example. In this example, a coreset for a NR-Light UE or the like may include CCEs of a legacy coreset 902 and CCEs of an extended coreset 904. In a particular example, a legacy coreset 902 may follow a legacy CCE mapping, which may include CCE0 through CCE15 as depicted. In an extended coreset, CCE mapping may assume the same number of symbols as in a legacy region, with CCE0 through CCE15, and continue the mapping in an extended coreset 904, e.g., in frequency and then time. As a result, a number of CCEs available to an NR-Light UE or the like may be the total number of CCEs from both a legacy coreset 902 and an extended coreset 904. For instance, the depicted example provides a total of 64 CCEs for an NR-Light UE. In certain embodiments, a lower coding rate may be employed to take advantage of the increase in a number of CCEs available to a NR-Light UE.

In the example in FIG. 9, where a NR-Light UE or the like may be configured with a higher aggregation level (e.g., 32 or 64), a legacy coreset 902 may include different configurations. In one example, a high aggregation level PDCCH may be scheduled only in an extended coreset 904, while aggregation levels less than or equal to 16 may be scheduled in a legacy coreset 902. In other words, CCEs greater than 16 can be scheduled in an extended coreset 904, while the remaining (lower) CCEs can be scheduled in a legacy coreset 902, as shown in the example in FIG. 9. In this example, there may be two PDCCH, such as one PDCCH with an aggregation level of 16 in the legacy coreset 902 for the legacy UEs and the NR-Light UEs, and another PDCCH with an aggregation level of 32 in the extended coreset for the NR-Light UE. It may occur that a NR-Light UE can decode the PDCCH with an aggregation level of 16 in a legacy coreset 902 when the NR-Light UE is in relatively good coverage. In such examples, a NR-Light UE can skip blind decoding on the extended coreset 904. In other example, a NR-Light UE can rely on a higher aggregation level in an extended coreset 904 when coverage is not as good in order to decode the PDCCH. In some examples, there may be two PDCCH transmissions instead of just one PDCCH transmission, where both PDCCHs may point to the same RMSI PDSCH.

In another example for a legacy coreset 902 configuration, a high aggregation level PDCCH may be scheduled in a combined legacy coreset 902 and an extended coreset 904. In this example, the legacy UE may be unable to decode the PDCCH as a result of the high aggregation levels in the legacy coreset 902. As a result, the legacy UE may decode the PDCCH in a later SSB. For example, referring back to FIG. 7, if a legacy UE is unable to decode a PDCCH in a legacy coreset 702, e.g., because of a higher aggregation level, a legacy UE or the like may detect SSB2, which will point to the second coreset 706, which the legacy UE can utilize to decode the PDCCH. In such embodiments, a first coreset 702 and an extended coreset 704 may be configured for NR-Light UEs or the like while a second coreset 706 may be configured for the legacy UEs or the like.

Referring again to FIG. 9, in some embodiments, an extended coreset 904 may be employed beyond a type 0 PDCCH with RMSI, such as for a UE specific PDCCH after a UE is connected, then interleaving may be utilized to interleave CCE mapping. Thus, for example, the same coreset interleaving utilized with a legacy coreset 902 may be utilized also for an extended coreset 904.

According to one or more aspects of the present disclosure, a scheduling entity may consider an extended coreset resource when scheduling a RMSI PDSCH for legacy UEs or the like. For example, a scheduling entity can avoid scheduling a PDSCH on an extended coreset. A scheduling entity may, for example, employ RMSI PDSCH repetition, such as shown in FIG. 7. The number of repetitions may be predefined in certain embodiments.

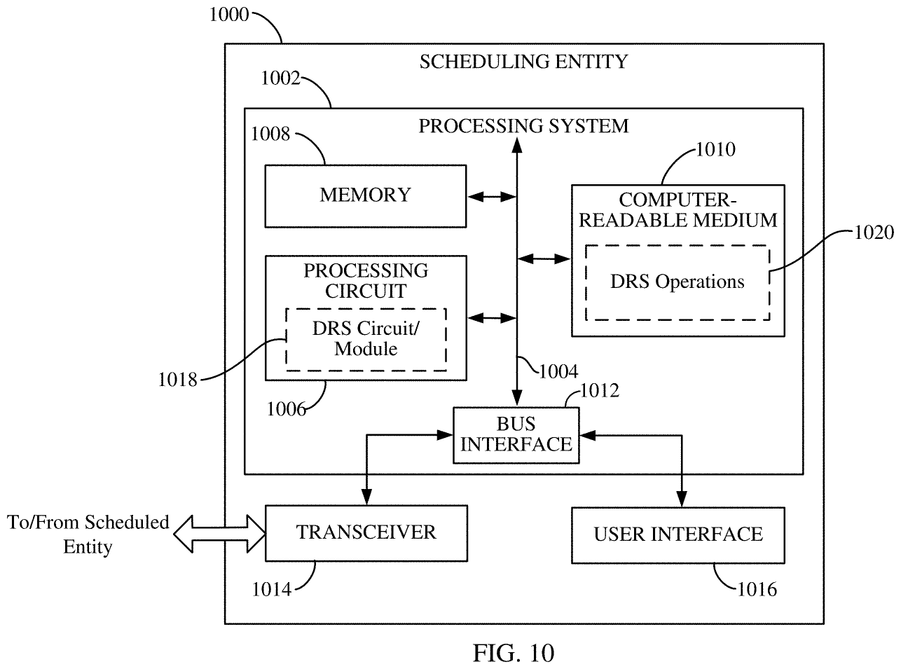

FIG. 10 is a block diagram illustrating select components of a scheduling entity 1000 employing a processing system 1002 according to at least one example of the present disclosure. In this example, the processing system 1002 is implemented with a bus architecture, represented generally by the bus 1004. The bus 1004 may include any number of interconnecting buses and bridges depending on the specific application of the processing system 1002 and the overall design constraints. The bus 1004 communicatively couples together various circuits including one or more processors (represented generally by the processing circuit 1006), a memory 1008, and computer-readable media (represented generally by the storage medium 1010). The bus 1004 may also link various other circuits such as timing sources, peripherals, voltage regulators, and power management circuits, which are well known in the art, and therefore, will not be described any further. A bus interface 1012 provides an interface between the bus 1004 and a transceiver 1014. The transceiver 1014 provides a means for communicating with various other apparatus over a transmission medium. For example, the transceiver 1014 may include an antenna array sized and shaped to facilitate beam-based communications (e.g., mmWave beam-based communications), and a receive chain to receive one or more wireless signals via the antenna array. The transceiver 1014 may also include a transmit chain to transmit one or more wireless signals via the antenna array. Depending upon the nature of the apparatus, a user interface 1016 (e.g., keypad, display, speaker, microphone, joystick) may also be provided.

The processing circuit 1006 is responsible for managing the bus 1004 and general processing, including the execution of programming stored on the computer-readable storage medium 1010. The programming, when executed by the processing circuit 1006, causes the processing system 1002 to perform the various functions described below for any particular apparatus. The computer-readable storage medium 1010 and the memory 1008 may also be used for storing data that is manipulated by the processing circuit 1006 when executing programming As used herein, the term “programming” shall be construed broadly to include without limitation instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The processing circuit 1006 is arranged to obtain, process and/or send data, control data access and storage, issue commands, and control other desired operations. The processing circuit 1006 may include circuitry adapted to implement desired programming provided by appropriate media, and/or circuitry adapted to perform one or more functions described in this disclosure. For example, the processing circuit 1006 may be implemented as one or more processors, one or more controllers, and/or other structure configured to execute executable programming and/or execute specific functions. Examples of the processing circuit 1006 may include a general purpose processor, a digital signal processor (DSP), an application specific integrated circuit (ASIC), a field programmable gate array (FPGA) and/or other programmable logic component, discrete gate or transistor logic, discrete hardware components, or any combination thereof designed to perform the functions described herein. A general purpose processor may include a microprocessor, as well as any conventional processor, controller, microcontroller, or state machine. The processing circuit 1006 may also be implemented as a combination of computing components, such as a combination of a DSP and a microprocessor, a number of microprocessors, one or more microprocessors in conjunction with a DSP core, an ASIC and a microprocessor, or any other number of varying configurations. These examples of the processing circuit 1006 are for illustration and other suitable configurations within the scope of the present disclosure are also contemplated.

In some instances, the processing circuit 1006 may include a DRS circuit and/or module 1018. The DRS circuit/module 1018 may generally include circuitry and/or programming (e.g., programming stored on the storage medium 1010) adapted to perform one or more of the operations described herein with reference to FIGS. 1 through 9 for a scheduling entity. As used herein, reference to circuitry and/or programming may be generally referred to as logic (e.g., logic gates and/or data structure logic).

The storage medium 1010 may represent one or more computer-readable devices for storing programming, such as processor executable code or instructions (e.g., software, firmware), electronic data, databases, or other digital information. The storage medium 1010 may also be used for storing data that is manipulated by the processing circuit 1006 when executing programming The storage medium 1010 may be any available non-transitory media that can be accessed by a general purpose or special purpose processor, including portable or fixed storage devices, optical storage devices, and various other mediums capable of storing, containing and/or carrying programming By way of example and not limitation, the storage medium 1010 may include a non-transitory computer-readable storage medium such as a magnetic storage device (e.g., hard disk, floppy disk, magnetic strip), an optical storage medium (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and/or other mediums for storing programming, as well as any combination thereof.

The storage medium 1010 may be coupled to the processing circuit 1006 such that the processing circuit 1006 can read information from, and write information to, the storage medium 1010. That is, the storage medium 1010 can be coupled to the processing circuit 1006 so that the storage medium 1010 is at least accessible by the processing circuit 1006, including examples where the storage medium 1010 is integral to the processing circuit 1006 and/or examples where the storage medium 1010 is separate from the processing circuit 1006 (e.g., resident in the processing system 1002, external to the processing system 1002, distributed across multiple entities).

Programming stored by the storage medium 1010, when executed by the processing circuit 1006, can cause the processing circuit 1006 to perform one or more of the various functions and/or process steps described herein. In at least some examples, the storage medium 1010 may include DRS operations 1020. The DRS operation 1020 are generally adapted to cause the processing circuit 1006 to perform one or more of the operations described herein with reference to FIGS. 1 through 9 for a scheduling entity.

Thus, according to one or more aspects of the present disclosure, the processing circuit 1006 is adapted to perform (independently or in conjunction with the storage medium 1010) any or all of the processes, functions, steps and/or routines for any or all of the scheduling entities described herein (e.g., scheduling entity 108, base station 210, 212, 214, 218, UE 238, quadcopter 220, transmitter 302, scheduling entity 1000). As used herein, the term “adapted” in relation to the processing circuit 1006 may refer to the processing circuit 1006 being one or more of configured, employed, implemented, and/or programmed (in conjunction with the storage medium 1010) to perform a particular process, function, step and/or routine according to various features described herein.

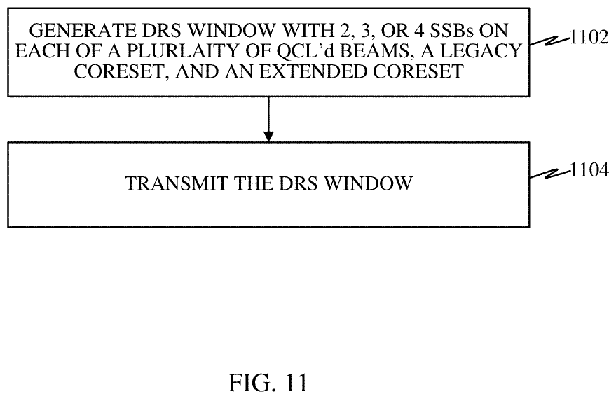

FIG. 11 is a flow diagram illustrating a wireless communication method (e.g., operational on or via a wireless communication device) according to some embodiments. As shown, a scheduling entity 1000 may generate at 1102 a DRS window with 2, 3, or 4 SSBs on each of a plurality of QCL'd beams, a legacy coreset, and an extended coreset. For example, the processing system 1002 may include logic (e.g., DRS circuit/module 1018, DRS operations 1020) to generate and map a DRS window including 2 or more SSBs on each of a plurality of QCL'd beams, a legacy coreset, and an extended coreset, as described in greater detail above with reference to FIGS. 5-9.

At 1104, the scheduling entity 1000 may transmit the generated DRS window. For example, the scheduling entity 1000 may transmit the DRS window via the transceiver 1014.

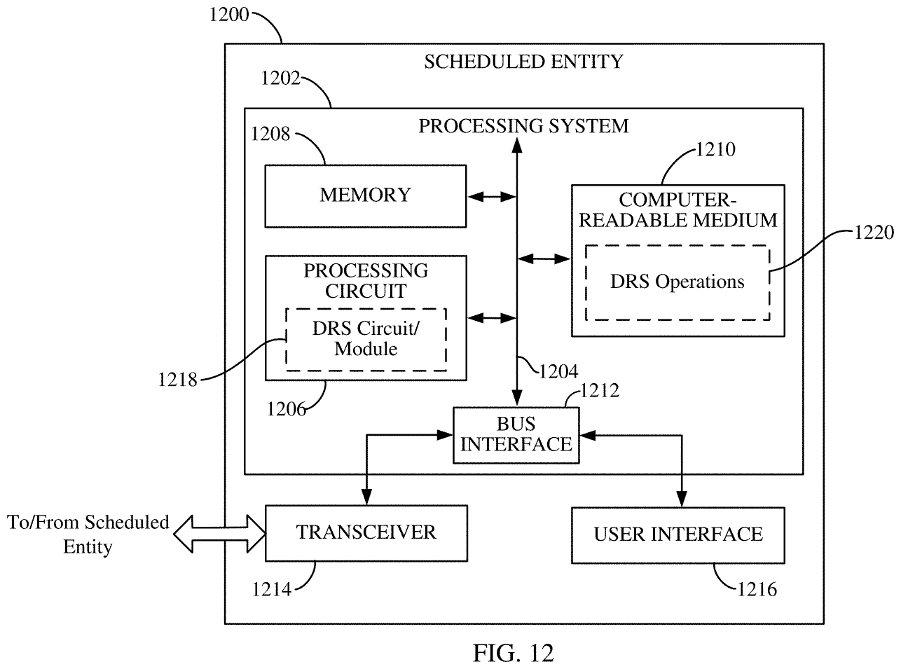

FIG. 12 is a block diagram illustrating select components of a scheduled entity 1200 employing a processing system 1202 according to at least one example of the present disclosure. Similar to the processing system 1002 in FIG. 10, the processing system 1202 may be implemented with a bus architecture, represented generally by the bus 1204. The bus 1204 may include any number of interconnecting buses and bridges depending on the specific application of the processing system 1202 and the overall design constraints. The bus 1204 communicatively couples together various circuits including one or more processors (represented generally by the processing circuit 1206), a memory 1208, and computer-readable media (represented generally by the storage medium 1210). The bus 1204 may also link various other circuits such as timing sources, peripherals, voltage regulators, and power management circuits, which are well known in the art, and therefore, will not be described any further. A bus interface 1212 provides an interface between the bus 1204 and a transceiver 1214. The transceiver 1214 provides a means for communicating with various other apparatus over a transmission medium. For example, the transceiver 314 may include a receive chain to receive one or more wireless signals, and/or a transmit chain to transmit one or more wireless signals. Depending upon the nature of the apparatus, a user interface 1216 (e.g., keypad, display, speaker, microphone, joystick) may also be provided.

The processing circuit 1206 is responsible for managing the bus 1204 and general processing, including the execution of programming stored on the computer-readable storage medium 1210. The programming, when executed by the processing circuit 1206, causes the processing system 1202 to perform the various functions described below for any particular apparatus. The computer-readable storage medium 1210 and the memory 1208 may also be used for storing data that is manipulated by the processing circuit 1206 when executing programming.

The processing circuit 1206 is arranged to obtain, process and/or send data, control data access and storage, issue commands, and control other desired operations. The processing circuit 1206 may include circuitry adapted to implement desired programming provided by appropriate media in at least one example, and/or circuitry adapted to perform one or more functions described in this disclosure. The processing circuit 1206 may be implemented and/or configured according to any of the examples of the processing circuit 1006 described above.

In some instances, the processing circuit 1206 may include a DRS circuit and/or module 1218. The DRS circuit/module 1218 may generally include circuitry and/or programming (e.g., programming stored on the storage medium 1210) adapted to perform one or more of the operations described herein with reference to FIGS. 1 through 9 for a scheduled entity. As noted previously, reference to circuitry and/or programming may be generally referred to as logic (e.g., logic gates and/or data structure logic).

The storage medium 1210 may represent one or more computer-readable devices for storing programming, such as processor executable code or instructions (e.g., software, firmware), electronic data, databases, or other digital information. The storage medium 1210 may be configured and/or implemented in a manner similar to the storage medium 1010 described above.

Programming stored by the storage medium 1210, when executed by the processing circuit 1206, can cause the processing circuit 1206 to perform one or more of the various functions and/or process steps described herein. In at least some examples, the storage medium 1210 may include DRS operations 1220 adapted to cause the processing circuit 1206 to perform one or more of the operations described herein with reference to FIGS. 1 through 9 for a scheduled entity. Thus, according to one or more aspects of the present disclosure, the processing circuit 1206 is adapted to perform (independently or in conjunction with the storage medium 1210) any or all of the processes, functions, steps and/or routines for any or all of the scheduled entities described herein (e.g., scheduled entity 106, UE 222, 224, 226, 228, 230, 232, 234, 236, 238, 240, and 242, receiver 306, scheduled entity 1200). As used herein, the term “adapted” in relation to the processing circuit 1206 may refer to the processing circuit 1206 being one or more of configured, employed, implemented, and/or programmed (in conjunction with the storage medium 1210) to perform a particular process, function, step and/or routine according to various features described herein.

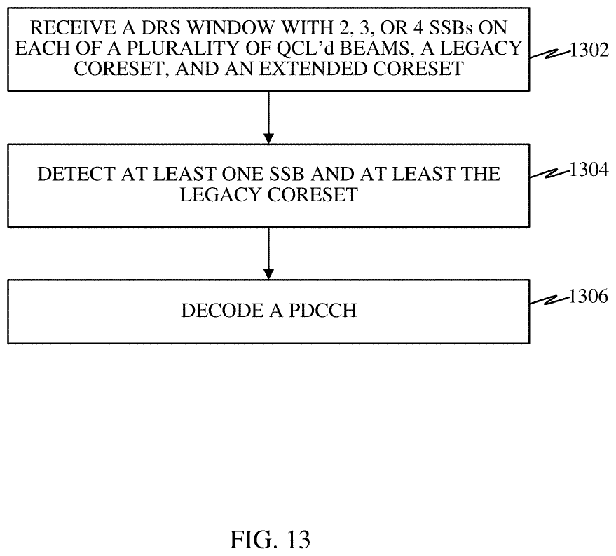

FIG. 13 is a flow diagram illustrating a wireless communication method (e.g., operational on or via a wireless communication device) according to some embodiments. As shown, a scheduled entity 1200 may receive a wireless transmission including a DRS window with 0 SSBs on each of a plurality of quasi co-located beams, a legacy coreset, and an extended coreset at 1302. For example, the processing system 1202 may include logic (e.g., DRS circuit/module 1218, DRS operations 1220) to receive a wireless transmission including a DRS window with 0 SSBs on each of a plurality of quasi co-located beams, a legacy coreset, and an extended coreset, as described in greater detail above with reference to FIGS. 5-9.

At 1304, the scheduled entity 1200 may detect at least one SSB and at least the legacy coreset. For example, the processing system 1202 may include logic (e.g., DRS circuit/module 1218, DRS operations 1220) to detect at least one SSB and at least the legacy coreset.

At 1306, the scheduled entity 1200 may decode a PDCCH. For example, the processing system 1202 may include logic (e.g., DRS circuit/module 1218, DRS operations 1220) to decode a PDCCH.

Several aspects of a wireless communication network have been presented with reference to an exemplary implementation. As those skilled in the art will readily appreciate, various aspects described throughout this disclosure may be extended to other telecommunication systems, network architectures and communication standards.

By way of example, various aspects may be implemented within other systems defined by 3GPP or combinations of such systems. These systems may include candidates such as 5G New Radio (NR), Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

While the above discussed aspects, arrangements, and embodiments are discussed with specific details and particularity, one or more of the components, steps, features and/or functions illustrated in FIGS. 1, 2, 3, 4, 5, 6, 7, 8, 9, 10, 11, 12, and/or 13 may be rearranged and/or combined into a single component, step, feature or function or embodied in several components, steps, or functions. Additional elements, components, steps, and/or functions may also be added or not utilized without departing from the novel features of the present disclosure. The apparatus, devices and/or components illustrated in FIGS. 1, 2, 3, 10, and/or 12 may be configured to perform or employ one or more of the methods, features, parameters, and/or steps described herein with reference to FIGS. 4, 5, 6, 7, 8, 9, 11, and/or 13. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The various features associate with the examples described herein and shown in the accompanying drawings can be implemented in different examples and implementations without departing from the scope of the present disclosure. Therefore, although certain specific constructions and arrangements have been described and shown in the accompanying drawings, such embodiments are merely illustrative and not restrictive of the scope of the disclosure, since various other additions and modifications to, and deletions from, the described embodiments will be apparent to one of ordinary skill in the art. Thus, the scope of the disclosure is only determined by the literal language, and legal equivalents, of the claims which follow.

1. A wireless communication device, comprising:
a transceiver;
a memory; and
a processor communicatively coupled to the transceiver and the memory, the processor configured to:
schedule a discovery reference signal (DRS) window including a plurality of synchronization signal blocks (SSBs) repetitions per beam, a first coreset, and a second coreset;
transmit the scheduled DRS window via the transceiver.

2. The wireless communication device of claim 1, wherein the plurality of SSBs comprise 2 SSBs, 3 SSBs or 4 SSBs.

3. The wireless communication device of claim 1, wherein the first coreset comprises a legacy coreset, and the second coreset comprises an extended coreset.

4. The wireless communication device of claim 1, wherein the DRS window comprises a duration greater than 5 milliseconds.

5. The wireless communication device of claim 1, wherein each of the plurality of SSBs indicates the first coreset and the second coreset for a first type of user equipment.

6. The wireless communication device of claim 5, wherein one or more SSBs of the plurality of SSBs indicates the first coreset for a second type of user equipment.

7. The wireless communication device of claim 1, wherein the first coreset includes a first group of CCEs, and wherein the second coreset includes one or more repetitions of the first group of CCEs in the first coreset.

8. The wireless communication device of claim 1, wherein the first coreset includes a first group of CCEs, and wherein the second coreset includes a second group of CCEs continued from the first group of CCEs in the first coreset.

9. The wireless communication device of claim 1, wherein the scheduled DRS window is transmitted in an unlicensed channel.

10. A method of wireless communication, comprising:
generating a discovery reference signal window including a plurality of synchronization signal blocks on each of a plurality of quasi co-located beams, a first coreset, and a second coreset; and
transmitting the discovery reference signal window.

11. The method of claim 10, wherein the plurality of synchronization signal blocks comprise 2 synchronization signal blocks, 3 synchronization signal blocks or 4 synchronization signal blocks.

12. The method of claim 10, wherein the first coreset comprises a legacy coreset, and the second coreset comprises an extended coreset.

13. The method of claim 10, wherein the DRS window comprises a duration greater than 5 milliseconds.

14. The method of claim 10, wherein each synchronization signal block indicates the first coreset and the second coreset for a first type of user equipment.

15. The method of claim 14, wherein one or more synchronization signal blocks indicates the first coreset for a second type of user equipment.

16. The method of claim 10, wherein the first coreset includes a first group of CCEs, and wherein the second coreset includes one or more repetitions of the first group of CCEs in the first coreset.

17. The method of claim 10, wherein the legacy coreset includes a first group of CCEs, and wherein the extended coreset includes a second group of CCEs continued from the first group of CCEs in the legacy coreset.

18. The method of claim 10, wherein transmitting the discovery reference signal window comprises transmitting the discovery reference signal window over an unlicensed channel.

19. An apparatus for wireless communication, comprising:
means for generating a discovery reference signal window including a plurality of synchronization signal blocks on each of a plurality of quasi co-located beams, a first coreset, and a second coreset; and
means for transmitting the discovery reference signal window.

20. A non-transitory processor-readable storage medium storing processor-executable instructions for causing a processing circuit to:
generate a discovery reference signal window including a plurality of synchronization signal blocks on each of a plurality of quasi co-located beams, a first coreset, and a second coreset; and
transmit the discovery reference signal window.

21. A wireless communication device, comprising:
a transceiver;
a memory; and
a processor communicatively coupled to the transceiver and the memory, the processor configured to:
receive, via the transceiver, a wireless transmission including a DRS window with a plurality of SSBs on each of a plurality of quasi co-located beams, a first coreset, and a second coreset;
detect at least one SSB and at least the first coreset; and
decode a PDCCH.

22. The wireless communication device of claim 21, wherein the plurality of SSBs comprise 2 SSBs, 3 SSBs or 4 SSBs.

23. The wireless communication device of claim 21, wherein the first coreset comprises a legacy coreset, and the second coreset comprises an extended coreset.

24. The wireless communication device of claim 21, wherein the DRS window comprises a duration greater than 5 milliseconds.

25. The wireless communication device of claim 21, wherein the wireless communication device comprises a NR-Light configured device, and wherein the processing circuit further detects the second coreset.

26. The wireless communication device of claim 21, wherein the wireless communication device comprises a legacy configured device.

27. The wireless communication device of claim 21, wherein the first coreset includes a first group of CCEs, and wherein the second coreset includes a second group of CCEs continued from the first group of CCEs in the first coreset.

28. The wireless communication device of claim 21, wherein the wireless transmission including the DRS window is received over an unlicensed channel.

29. A method of wireless communication, comprising:
receiving a wireless transmission including a DRS window with a plurality of SSBs on each of a plurality of quasi co-located beams, a first coreset, and a second coreset;
detecting at least one SSB and at least the first coreset; and
decoding a PDCCH.

30. The method of claim 29, wherein the plurality of SSBs comprise 2 SSBs, SSBs or 4 SSBs.

31. The method of claim 29, wherein the first coreset comprises a legacy coreset, and the second coreset comprises an extended coreset.

32. The method of claim 29, wherein the DRS window comprises a duration greater than 5 illiseconds.

33. The method of claim 29, wherein receiving the wireless transmission comprises receiving the wireless transmission at a NR-Light configured device, and wherein detecting at least one SSB and at least the first coreset further comprises detecting the second coreset.

34. The method of claim 29, wherein receiving the wireless transmission comprises receiving the wireless transmission at a legacy configured device.

35. The method of claim 29, wherein the first coreset includes a first group of CCEs, and wherein the second coreset includes a second group of CCEs continued from the first group of CCEs in the first coreset.

36. The method of claim 29, wherein the first coreset includes a first group of CCEs, and wherein the second coreset includes one or more repetitions of the first group of CCEs in the first coreset.

37. The method of claim 29, wherein the wireless transmission including the DRS window is received over an unlicensed channel.

38. (canceled)

39. (canceled)
